(19) United States
(12) Patent Application Publication
(10) Pub. No.: US 2012/0147342 A1
(43) Pub. Date: Jun. 14, 2012

(54) PROJECTION APPARATUS

(75) Inventors: Yi-Hsin Lin, Taoyuan County (TW); Hung-Chun Lin, Nantou County (TW)

(73) Assignee: NATIONAL CHIAO TUNG UNIVERSITY, Hsinchu City (TW)

(21) Appl. No.: 12/967,067

(22) Filed: Dec. 14, 2010

(51) Int. Cl. G03B 3/04

(52) U.S. Cl. 353/122

(57) ABSTRACT

A projection apparatus including an illumination system, a light valve, and an imaging system is provided. The illumination system is for emitting an illumination beam. The light valve is disposed on a transmission path of the illumination beam for converting the illumination beam into an image beam. The imaging system includes a projection lens and an electrically tunable focusing lens. The projection lens is disposed on the transmission path of the image beam. The electrically tunable focusing lens is disposed on the transmission path of the image beam. The electrically tunable focusing lens changes a focal length thereof by electricity but not by a mechanism moving positions of lenses.

### BACKGROUND OF THE INVENTION

1. Field of the Invention

The invention generally relates to a displaying apparatus and, in particular, to a projection apparatus.

2. Description of Related Art

Along with the development of the optical and electronic technology, displaying apparatuses including projection apparatuses are made smaller and smaller.

As such, projection apparatuses can be combined into portable electronic devices, such as cell phones, digital cameras, notebook computer, tablet computers, personal digital assistants, and so on. When a portable electronic device is combined with a micro-projector, the display frame is no more limited by the small surface area of the portable electronic device. Instead, the micro-projector projects a larger display frame onto a screen or wall. As a result, although the portable electronic device is small, a larger display frame is still achieved to share with more viewers.

Conventional micro-projectors adopt manual projection lenses to focus the display frame. Specifically, a conventional manual projection lens includes a plurality of lenses, and a user adjusts a mechanism, e.g. rotating an adjustment ring, to adjust the distances between the lenses or the positions of the lenses, so as to change the focal length of the manual projection lens. As a result, the display frame is focused.

If a motor is used to drive the lenses of the projection lens to certain positions for focusing the display frame, the motor increases the power consumption of the micro-projector, the mechanism becomes complex and fragile, and the overall volume of the micro-projector is increased. For a portable electronic device, the above drawbacks are vital and limit the applicability of the portable electronic device.

### SUMMARY OF THE INVENTION

Accordingly, the invention is directed to a projection apparatus.

An embodiment of the invention provides a projection apparatus including an illumination system, a light valve, and an imaging system. The illumination system is for emitting an illumination beam. The light valve is disposed on a transmission path of the illumination beam for converting the illumination beam into an image beam. The imaging system includes a projection lens and an electrically tunable focusing lens. The projection lens is disposed on the transmission path of the image beam. The electrically tunable focusing lens is disposed on the transmission path of the image beam. The electrically tunable focusing lens changes a focal length thereof by electricity but not by a mechanism moving positions of lenses.

In the projection apparatus according to the embodiment of the invention, since the electrically tunable focusing lens changes the focal length thereof by electricity but not by a mechanism moving positions of lenses, the overall volume of the projection apparatus can be reduced, the structure of the projection apparatus is simple, and the power consumption of the imaging system is reduced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic structural view of a projection apparatus according to an embodiment of the invention.

FIGS. 2A and 2B are schematic structural views of the electrically tunable focusing lens in FIG. 1 respectively on a voltage-off state and a voltage-on state.

FIG. 3 shows that the focal length of the electrically tunable focusing lens in FIG. 1 changes with the voltage applied to the electrically tunable focusing lens.

FIG. 4 shows that the image distance changes with the voltage applied to the electrically tunable focusing lens in FIG. 1.

FIG. 5 is a schematic structural view of a projection apparatus according to another embodiment of the invention.

FIG. 6 is a schematic structural view of a projection apparatus according to yet another embodiment of the invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

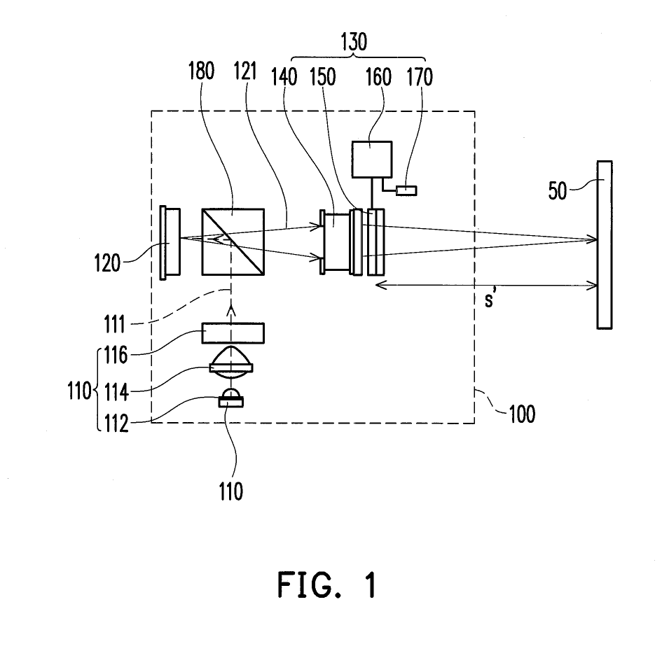

FIG. 1 is a schematic structural view of a projection apparatus according to an embodiment of the invention. Referring to FIG. 1, the projection apparatus 100 of this embodiment includes an illumination system 110, a light valve 120, and an imaging system 130. The illumination system 110 is for emitting an illumination beam 111. In this embodiment, the illumination system 110 includes a light emitting device 112, a lens 114, and a polarizer 116. The light emitting device 112 is, for example, a light emitting diode (LED) which is adapted to emit the illumination beam 111. However, in other embodiments, the light emitting device 112 may also be an ultra high pressure (UHP) lamp or another light source. The lens 114 and the polarizer 116 are disposed on the transmission path of the illumination beam 111.

The light valve 120 is disposed on a transmission path of the illumination beam 111 for converting the illumination beam 111 into an image beam 121. In this embodiment, the light valve 120 is, for example, a liquid-crystal-on-silicon (LCOS) panel. However, in other embodiments, the light valve 120 may also be a digital micro-mirror device (DMD). The imaging system 130 is disposed on the transmission path of the image beam 121. Specifically, in this embodiment, the projection apparatus 100 further includes a beam splitter 180 disposed on both the transmission paths of the illumination beam 111 and the image beam 121. The beam splitter 180 transmits the illumination beam 111 from the illumination system 110 to the light valve 120, and transmits the image beam 121 from the light valve to the imaging system 130. In this embodiment, the beam splitter 180 is a polarizing beam splitter (PBS) which reflects an s-polarized portion of the illumination beam 111 to the light valve 120 and allows a p-polarized portion of the image beam 121 to pass through and be transmitted to the imaging system 130. In other embodiment, the PBS may allows the p-polarized portion of the illumination beam 111 from the illumination system 110 to pass through and be transmitted to the light valve 120 and reflects the s-polarized portion of the image beam 121 from the light valve 120 to the imaging system 130. Moreover, in other embodiments, the beam splitter 180 may be a total internal reflection (TIR) prism or another type of beam splitter.

The imaging system 130 includes a projection lens 140 and an electrically tunable focusing lens 150. The projection lens 140 is disposed on the transmission path of the image beam 121. The electrically tunable focusing lens 150 is disposed on the transmission path of the image beam 121. The electrically tunable focusing lens 150 changes a focal length thereof by electricity but not by a mechanism moving positions of lenses. In this embodiment, the electrically tunable focusing lens 150 is a liquid crystal lens. The electrically tunable focusing lens 150 changes the focal length thereof for imaging the image beam 121 onto a screen, so as to form an image frame on the screen. That is to say, the electrically tunable focusing lens 150 changes its focal length to focus. However, in other embodiments, the electrically tunable focusing lens 150 may also be a liquid lens.

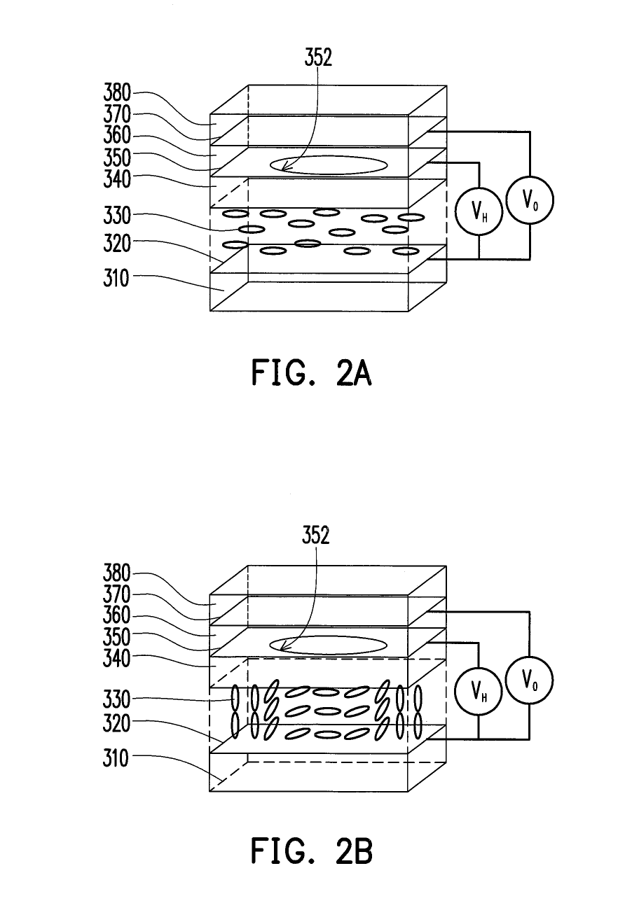

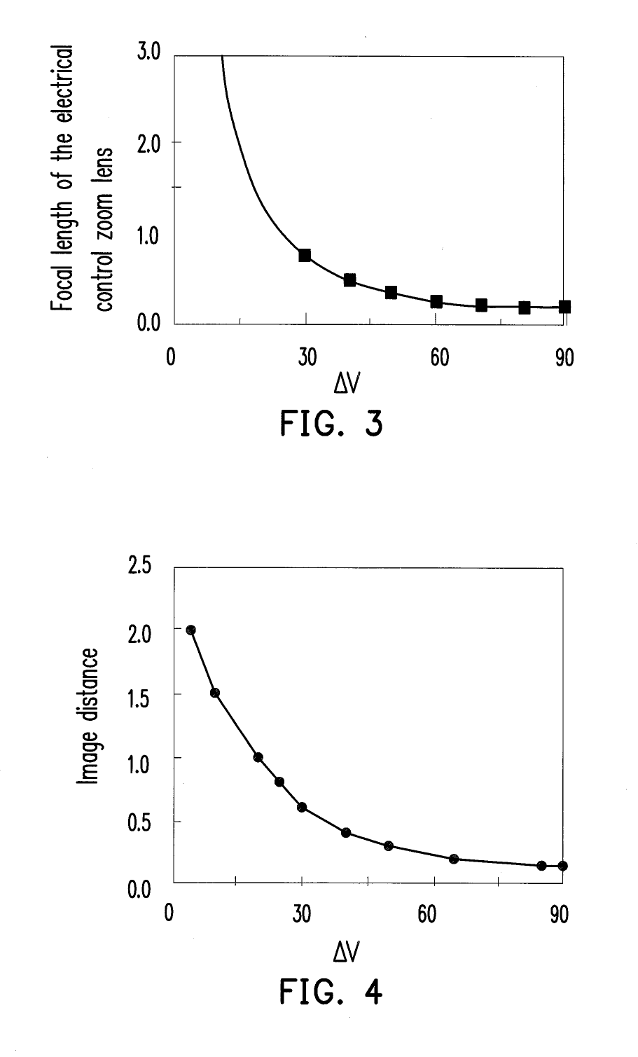

In this embodiment, the projection lens 140 is disposed between the light valve 120 and the electrically tunable focusing lens 150. Moreover, in this embodiment, the projection apparatus 100 further includes a control unit 160 electrically connected to the electrically tunable focusing lens 150 for changing the focal length of the electrically tunable focusing lens 150. The control unit 160 applies voltage to the electrically tunable focusing lens 150 and changes the focal length of the electrically tunable focusing lens 150 by adjusting the voltage applied to the electrically tunable focusing lens 150. Specifically, referring to FIGS. 2A and 2B which are schematic structural views of the electrically tunable focusing lens 150 in FIG. 1 respectively on a voltage-off state and a voltage-on state, in this embodiment, the electrically tunable focusing lens 150 includes a substrate 310, a transparent electrode 320, a liquid crystal layer 330, a substrate 340, a transparent electrode 350, an optical adhesive layer 360, a electrode 370, and a substrate 380 disposed in sequence on the transmission path of the image beam 121. A voltage V_{H} is applied between the transparent electrode 350 and the transparent electrode 320, a voltage V_{O} is applied between the transparent electrode 370 and the transparent electrode 320, and ΔV≡V_{H}−V_{O}. In this embodiment, when ΔV=0, i.e. the control unit 160 not applying voltage to the electrically tunable focusing lens 150, the liquid crystal molecules of the liquid crystal layer 330 lie down and are parallel to the transparent electrodes 320, 350, and 370. In this state, the electrically tunable focusing lens 150 acts as a transparent plate and the focal length thereof is infinite, as shown in FIG. 3 which shows that the focal length of the electrically tunable focusing lens 150 changes with the voltage applied to the electrically tunable focusing lens 150.

On the other hand, when ΔV≠0, i.e. the control unit 160 applying voltage to the electrically tunable focusing lens 150, since the electrode 350 has a hole to generate a non-uniform electrical field, at least a part of the liquid crystal molecules in the liquid crystal layer 330 stand up and the orientations of the liquid crystal molecules are non-uniform. In this state, the electrically tunable focusing lens 150 acts as a convex lens. Moreover, the more ΔV is, the less the focal length of the electrically tunable focusing lens 150 is. Since the focal length of the electrically tunable focusing lens 150 can be changed, the image frame projected by the projection apparatus 100 can be clearly formed on the screen 50 at different image distances s′, wherein the image distance s′ is defined as a distance from the imaging system 130 to the screen 50. FIG. 4 shows that the image distance s′, where the image frame is clear, changes with ΔV. The more ΔV is, the less the image distance s′ is. The experiment data of FIGS. 3 and 4 prove that the electrically tunable focusing lens 150 does achieve focusing. If a alternating current (AC) is applied to the electrically tunable focusing lens 150, ΔV in FIGS. 3 and 4 is referred to a root-mean-square value.

In the projection apparatus 100 according to this embodiment, since the electrically tunable focusing lens 150 changes the focal length thereof by electricity but not by a mechanism moving positions of lenses, the overall volume of the projection apparatus 100 can be reduced, the structure of the projection is simple, and the power consumption of the imaging system is reduced. This is because the electrically tunable focusing lens 150 may not need to use a complex mechanism to change the position of the lenses so as to change a focal length. As a result, the applicability of the projection apparatus 100 is increased. For example, the projection apparatus 100 may be combined into a portable electronic device, such as a cell phone, a digital cameras, a notebook computer, a tablet computer, a personal digital assistant, and so on, and does not occupy large space in the portable electronic device, and does also not consume large power of the portable electronic device.

In this embodiment, the control unit 160 may change the focal length of the electrically tunable focusing lens 150 step by step discontinuously. That is, the control unit 160 is adapted to apply a plurality of discontinuous voltages one by one to the electrically tunable focusing lens 150 so as to change the focal length discontinuously. However, in other embodiment, the control unit 160 may change the focal length of the electrically tunable focusing lens 150 gradually and continuously. That is to say, the control unit 160 may adjust the voltage applied to the electrically tunable focusing lens 150 continuously and gradually, so as to change the focal length gradually and continuously.

In this embodiment, the projection apparatus 100 further includes a rangefinder 170 electrically connected to the control unit 160 for determining a distance between the projection apparatus 100 and the screen 50, and the control unit 160 changes the focal length of the electrically tunable focusing lens 150 according to the distance determined by the rangefinder 170. That is to say, the imaging system 130 may focus automatically. In this embodiment, the rangefinder 170 is an infrared rangefinder or a microwave rangefinder. However, in other embodiments, the rangefinder 170 may be replaced by an optical detector electrically connected to the control unit 160 for detecting an image on the screen produced by the image beam, and the control unit 160 adjusts the focal length of the electrically tunable focusing lens 150 to a value where contrast of the image is substantially maximum. As a result, the imaging system can also focus automatically.

However, in other embodiment, the imaging system 130 may also focus manually. A knob, button, or other user's interfaces may be electrically connected to the control unit 160, and a user can change the focal length of the electrically tunable focusing lens 150 by operate the knob, button, or user's interfaces.

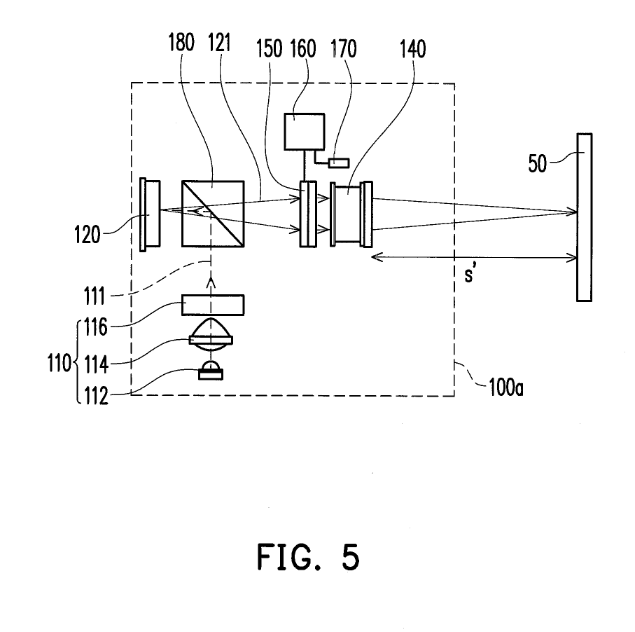

FIG. 5 is a schematic structural view of a projection apparatus according to another embodiment of the invention. Referring to FIG. 5, the projection apparatus 100a of this embodiment is similar to the projection apparatus 100 in FIG. 1, and the difference therebetween is as follows. In the projection apparatus 100a, the electrically tunable focusing lens 150 is disposed between the light valve 120 and the projection lens 140. The advantages and effects of the projection apparatus 100a are the same as those of the above projection apparatus 100, and are not repeated herein.

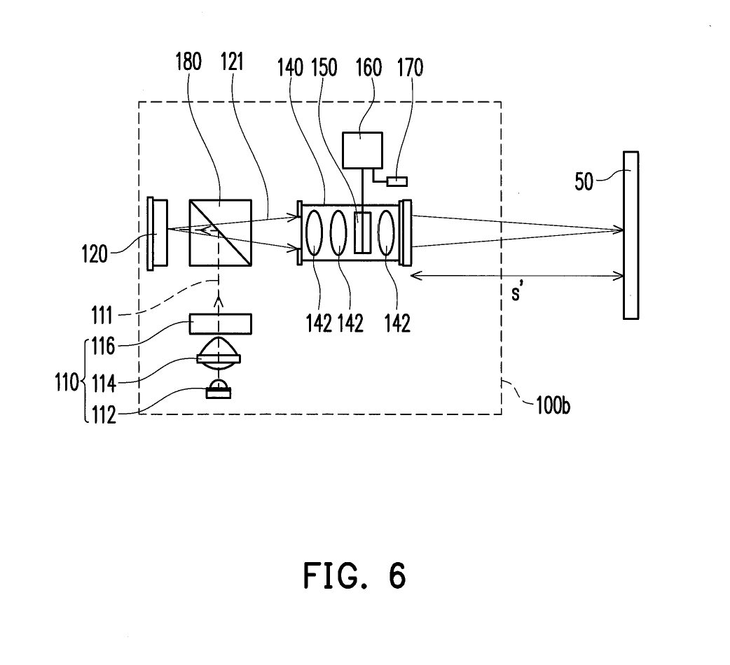

FIG. 6 is a schematic structural view of a projection apparatus according to yet another embodiment of the invention. Referring to FIG. 6, the projection apparatus 100b of this embodiment is similar to the projection apparatus 100 in FIG. 1, and the difference therebetween is as follows. In the projection apparatus 100b, the electrically tunable focusing lens 150 is disposed within the projection lens 140. In this embodiment, the electrically tunable focusing lens 150 is disposed between the lenses of the projection lens 140. The advantages and effects of the projection apparatus 100b are the same as those of the above projection apparatus 100, and are not repeated herein.

In view of the above, in the projection apparatus according to the embodiments of the invention, since the electrically tunable focusing lens changes the focal length thereof by electricity but not by a mechanism moving positions of lenses, the overall volume of the projection apparatus can be reduced, the structure of the projection apparatus is simple, and the power consumption of the imaging system is reduced. This is because the electrically tunable focusing lens may not need to use a complex mechanism to change the position of the lenses so as to change a focal length. As a result, the applicability of the projection apparatus is increased. For example, the projection apparatus according to the embodiments of the invention may be combined into a portable electronic device, such as a cell phone, a digital cameras, a notebook computer, a tablet computer, a personal digital assistant, and so on, and does not occupy large space in the portable electronic device, and does also not consume large power of the portable electronic device.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A projection apparatus comprising:
an illumination system for emitting an illumination beam;
a light valve disposed on a transmission path of the illumination beam for converting the illumination beam into an image beam; and
an imaging system comprising:
a projection lens disposed on the transmission path of the image beam; and
an electrically tunable focusing lens disposed on the transmission path of the image beam, wherein the electrically tunable focusing lens changes a focal length thereof by electricity but not by a mechanism moving positions of lenses.

2. The projection apparatus according to claim 1, wherein the electrically tunable focusing lens changes the focal length thereof for imaging the image beam onto a screen.

3. The projection apparatus according to claim 1, wherein the electrically tunable focusing lens is a liquid crystal lens or a liquid lens.

4. The projection apparatus according to claim 3, wherein the projection lens is disposed between the light valve and the electrically tunable focusing lens.

5. The projection apparatus according to claim 3, wherein the electrically tunable focusing lens is disposed between the light valve and the projection lens.

6. The projection apparatus according to claim 3, wherein the electrically tunable focusing lens is disposed within the projection lens.

7. The projection apparatus according to claim 1 further comprising a control unit electrically connected to the electrically tunable focusing lens for changing the focal length of the electrically tunable focusing lens.

8. The projection apparatus according to claim 7, wherein the control unit applies voltage to the electrically tunable focusing lens and changes the focal length of the electrically tunable focusing lens by adjusting the voltage applied to the electrically tunable focusing lens.

9. The projection apparatus according to claim 8, wherein the control unit changes the focal length of the electrically tunable focusing lens step by step discontinuously.

10. The projection apparatus according to claim 8, wherein the control unit changes the focal length of the electrically tunable focusing lens gradually and continuously.

11. The projection apparatus according to claim 7, wherein the imaging system is adapted to project the image beam onto a screen, the projection apparatus further comprises a rangefinder electrically connected to the control unit for determining a distance between the projection apparatus and the screen, and the control unit changes the focal length of the electrically tunable focusing lens according to the distance determined by the rangefinder.

12. The projection apparatus according to claim 11, wherein the rangefinder is an infrared rangefinder or a microwave rangefinder.

13. The projection apparatus according to claim 7, wherein the imaging system is adapted to project the image beam onto to a screen, the projection apparatus further comprises an optical detector electrically connected to the control unit for detecting an image on the screen produced by the image beam, and the control unit adjusts the focal length of the electrically tunable focusing lens to a value where contrast of the image is substantially maximum.

14. The projection apparatus according to claim 1, wherein the light valve is a liquid-crystal-on-silicon panel or a digital micro-mirror device.
